(19) United States
(12) Patent Application Publication
(10) Pub. No.: US 2002/0158176 A1
(43) Pub. Date: Oct. 31, 2002

(54) Universal keyboard and mouse platform

(75) Inventor: Robert C. Gilbertson, Toronto (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ISE, INC.

(21) Appl. No.: 09/843,207

(22) Filed: Apr. 26, 2001

(51) Int. Cl. B65D 19/00; A47G 29/00; B68G 5/00; E04G 3/00

(52) U.S. Cl. 248/346.01; 248/118; 248/918; 248/284.1

(57) ABSTRACT

An integral keyboard and mouse platform assembly is adapted for use on straight, curved or diagonal work surfaces of a work desk. The platform comprises a platter having a front edge, opposing side edges and rear edge. The rear edge is defined by a radiused transition from each side edge into a rearwardly projecting tongue. The front edge has a scalloped face with three symmetrical forwardly protecting lobes. The rearwardly projecting tongue has securements on its underside for securements to a suitable mount. The side edges are space apart sufficiently to provide a keyboard support and a mouse support all on the level of the upper surface of the platter. A keyboard palm rest is provided for attachment to the front edge and extends across to the forwardly projecting lobes and a mouse palm rest for attachment to the front edge and extending across one of the lobes to proved for the right hand or left hand mousing areas on the platter. With the keyboard palm rest removed the two lobes are aligned with a V-shaped keyboard having integral palm rest. This type of integral keyboard and mouse platform is universal not only for keyboards but as well as for various shaped work surfaces and right or left hand use.

### FIELD OF THE INVENTION

This invention relates to an integral keyboard and mouse platform assembly and more particularly the universal aspects of the platform as it would apply to mounting on straight, curved or diagonal worksurfaces, accommodate various types of keyboards and provide for right or left hand mouse location.

### BACKGROUND OF THE INVENTION

A variety of platforms are available to support computer keyboards and computer mouse attachments. There is a conventional style of rectangle shape keyboard as well as the ergonomics style such as described in Canadian Patent No 2,104,586 which has a somewhat V-shape for the left and right hand computer blocks of keys. Exemplary types of keyboard platforms are described in U.S. Pat. Nos. 6,045,098 and 6,098,935. These platforms are particularly suited to accommodate the conventional style of rectangular keyboard but do not readily lend themselves to other types of keyboards. In U.S. Pat. No. 6,045,098 the option of a right or left hand mousing area is provided. However the system does not include a palm rest for the mousing area and secondly the mouse support is at a different level than the level of the keyboard. In U.S. Pat. No. 6,098,935 a separate distinct mousing area is not contemplated. Instead the platform is designed for the conventional rectangular shaped keyboard. The platform includes a decorative tongue portion for covering up the mechanical device to provide for height adjustment of the platform.

U.S. Pat. No. 5,170,971 describes a detachable wrist supporter which may be secured to the edge of a table on which a computer keyboard and computer is mounted. This is quite distinct from a separate slideable platform for supporting the keyboard.

There continues to be a significant demand for a single platform which can accommodate different types of keyboards, provide right and left hand mousing areas on the same plane as the keyboard and can accommodate various shaped worksurfaces weather they be straight, curved or diagonal.

### SUMMARY OF THE INVENTION

In accordance with an aspect of this invention, a universal keyboard and mouse assembly is provided which can accommodate varying shape worksurfaces.

According to an aspect of the invention, an integral keyboard and mouse platform assembly for mounting on a workdesk is provided, the platform being adapted for use on straight, curved or diagonal worksurfaces.

The platform comprises;

i) a platter having a front edge, opposing side edges and a rear edge, the rear edge being defined by a radiused transition from each side edge into a rearwardly projecting tongue, the front edge having a scalloped face with three symetrical forwardly projecting lobes;

ii) the rearwardly projecting tongue having securements on its underside for securement to a suitable mount;

iii) the side edges being space apart sufficiently to provide a keyboard support and a mouse support all on one level of an upper surface of the planer; and

iv) a keyboard palm rest for attachment to the front edge and extending across two of the forwardly projecting lobes and a mouse palm rest for attachment to the front edge and extending across one of the lobes to provide right or left hand mousing areas on the platter.

### BRIEF DESCRIPTION OF THE DRAWINGS

Preferred embodiments of the invention are described with respect to the drawings wherein:

FIG. 1 is a top plan view of an operator at a diagonal workstation with a standard keyboard and mousing system.

FIG. 2 is a top plan view of applicant's keyboard platform in a curved workstation with the keyboard and mouse on the same plane.

FIG. 3 is an exploded view from above and in perspective of the platform assembly.

FIG. 4 is an exploded view from underneath in perspective of the platform assembly.

FIG. 5 is a section through the keyboard platform as mounted to a workstation.

FIG. 6 is a perspective view of the keyboard platform with a V-shape keyboard system mounted thereon.

FIG. 7 is a top plan view of the platform assembly mounted on the twelve inch radius workstation.

FIG. 8 is a top plan view of the platform assembly mounted on an eighteen inch radius curved workstation.

FIG. 9 is a top plan view of the keyboard platforms as cut out from a sheet of stock to minimised material waste.

### DETAILED DESCRIPTION OF THE PREFERRED EMBODIMENTS

A conventional prior art platform system is shown for use in diagonal area of a workstation 10. The computer monitor 12 is positioned behind the diagonal defined by worksurface edges 14 and 16. A tray 18 bridges edges 14 and 16 to defined a support for the conventional rectangular keyboard 20. A mouse pad 22 is provided off to the right of the keyboard 20 with the mouse wire leading off to the CPU. A plane for the computer monitor 12 is defined by dotted line 26. Due to the mouse pad 22 being located to the right of the keyboard 20 and perhaps on a different level, the operator 28 must rotate their body such that the plane through their shoulders defined by dotted line 30, is at an acute angle to the plane 26 of the monitor 12. When the operator resumes typing at the keyboard 20 the plane 30 through the shoulders will then become parallel with the plane 26 of the monitor. As can be appreciated, throughout the day the operator moves from the keyboard to the mouse pad and back numerous times. This requires twisting of the back, resulting in considerable fatigue and perhaps even repetitive strain injuries over prolong periods of computer use.

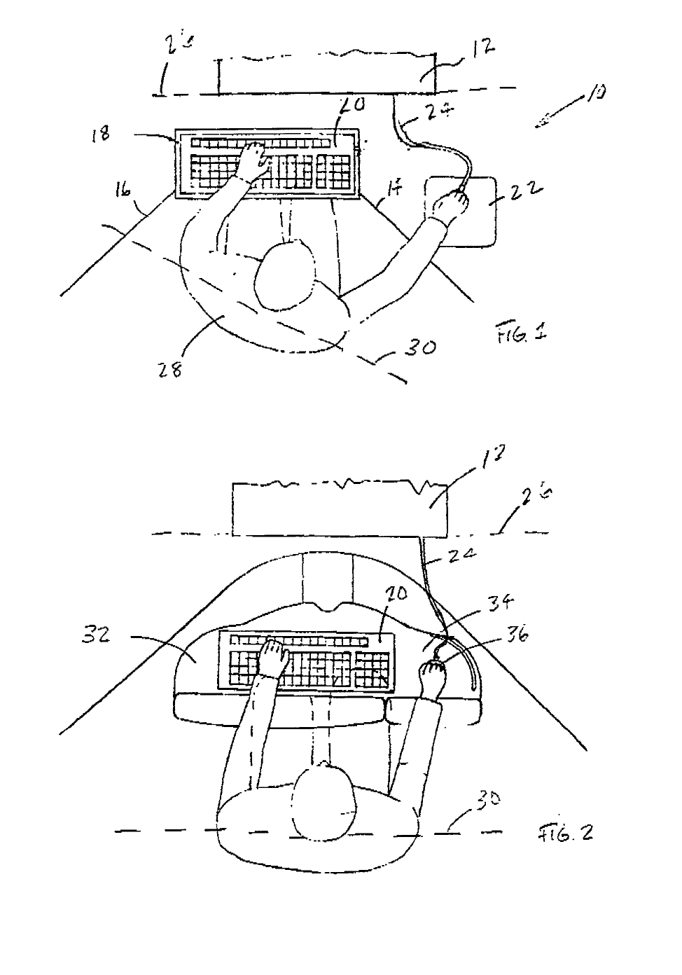

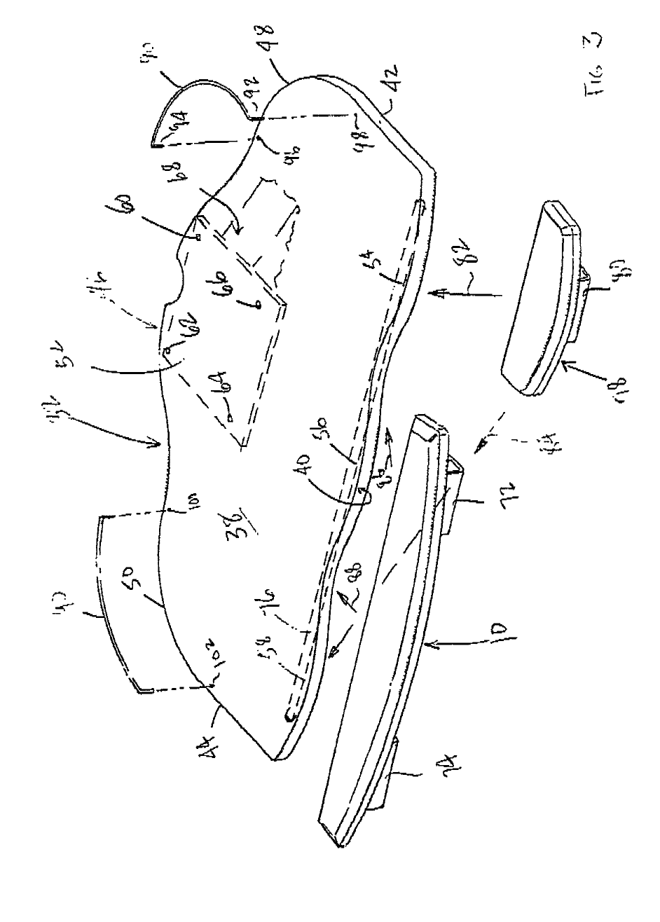

In accordance with an embodiment of the invention shown in FIG. 2, this problem is eliminated and at the same time the platform for the keyboard can be used on a variety of worksurface stations including straight edge, diagonal and curved. As shown in FIG. 2, the plane of the monitor is defined by cash line 26 and the plane through the operator's shoulder is at 30. The platform assembly in accordance with an aspect of this invention is shown at 32. The plane through the operator's shoulder 30 is parallel to the plane of the monitor 12. The operator does not have to turn sideways to use the mouse, because the mouse is in front of him and at the arm level so that minimal if any strain is placed on the back due to repetitive twisting. The platform assembly 32 is large enough to accommodate both the keyboard 20 and a mousing area 34 for the mouse 36. The shape of the platform assembly is such that it is readily usable on worksurface straight edges, diagonals of FIG. 1 and curves of FIG. 2. As will be later discussed the platform assembly is designed to be used with a 12 inch radius or greater for the curvature of the worksurface edge, with a 11 inch diagonal or greater or with a long worksurface side edge.

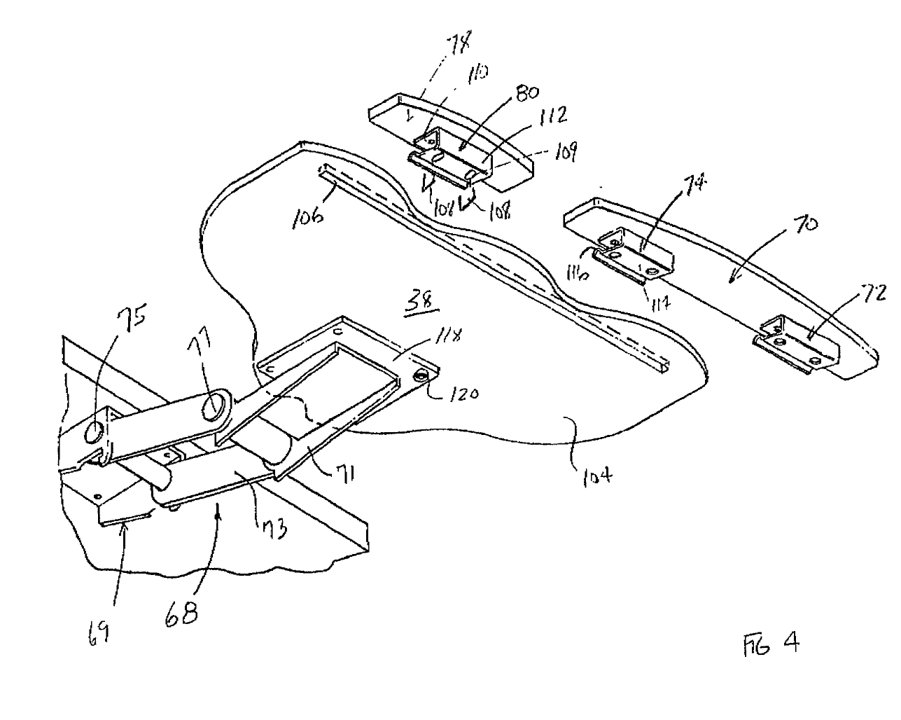

With reference to the platform assembly 32 as shown in FIG. 3, a platter 38 is provided with a front edge 40, opposing side edges 42 and 44 and a rear edge 46. The rear edge is defined by radius transition 48 and 50 into a rearwardly projecting tongue portion 52. The front edge 40 has a scalloped face with three symmetrical forwardly projecting lobes 54, 56 and 58. The rearwardly projecting tongue 52 has securements on its underside and which are shown in dot in FIG. 3 at 60, 62, 64 and 66. These SO securements permit mounting to an appropriate slide whose rear arm is shown in cot at 68. A keyboard palm rest 70 is provided for attachment to the platter 38. The keyboard palm rest extends across two of the forwardly projecting lobes 56 and 58 in this embodiment and are secured to the front edge 40 by suitable clips 72 and 74 which are described in more detail in the following views. A detent 76 is provided on the underside of the platter to engage the clips 72 and 74. Similarly a mouse palm rest 78 is provided and overlaps, the remaining lobe 54. The mouse palm rest 78 has a clip 80 for securement to the front edge 40 of the respective lobe 54. The mouse palm rest may be applied to the right hand side as indicted by arrow 82 or the left hand side as indicated by arrow 84. Correspondingly, the keyboard palm rest is shifted in a direction of arrows 86 or 88 depending upon the location of the mouse pad 78.

The platform assembly also includes a removable guide 90 which can be secured to either the right hand side or left hand side as indicated by radiused portions 48 and 50 respectively. The guide 90 is provided to contain the mouse wire and to ensure that the mouse does not fall off the rear edge of the platform. The guide 90 has depending legs 90 to and 94 which are inserted into the pre-drilled holes 96 and 98. Corresponding holes 100 and 102 are provided near the radiused portion 50 to provide for the mouse on the left hand side.

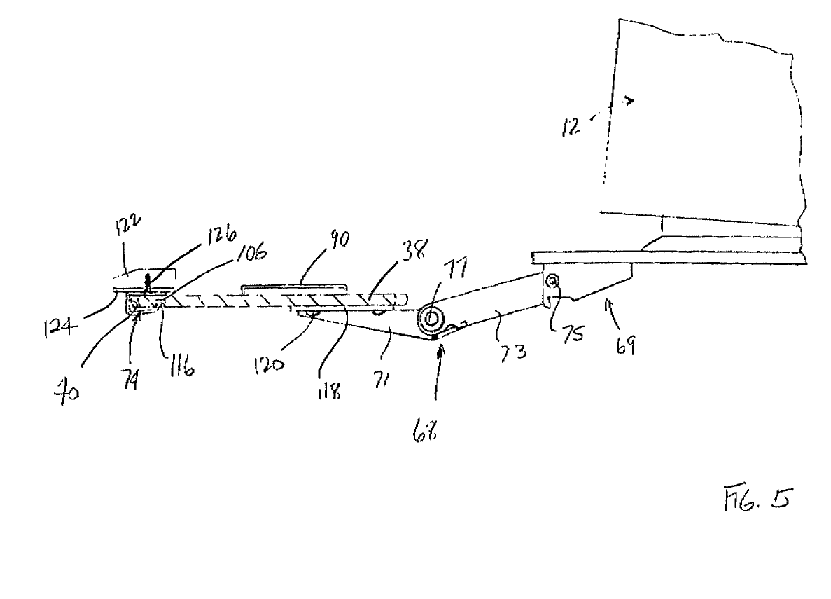

With reface to FIG. 4 the underside 104 of the platform assembly, a detent 106 is machined into the underside 104 of the platter 38. The detent 1106 maybe in the form of a grouse or channel which is machined in the under surface. The channel may be machined by a router or the like. The clips 72, 74 and 80 for the keyboard palm rest 70 and the mouse palm rest 78 are shown. The clips 80 are stapled by staples 108 extending through elongate apertures 110 to secure the clip to the underside of the respective keyboard palm rest and the mouse palm rest. Each clip is C-shaped in cross section with a base 110, depending leg 112 and inwardly extending lip 114 with an inward projection 116. The inward projection 116 snaps fit into the grove 106 by way of the lip 114 moving away from the base 110 as accommodate by the spring action in the leg 112. With the respective projection 116 snap fitted into the grove 106, the respective keyboard palm rest and mouse palm rest are fixed in position. The arm 68 for the slide 69 is shown in more detail in FIGS. 4 and 5. The arm 68 comprises two links 71 and 73. Link 73 is pivotally secured to slide 69 at 75. Links 71 and 73 are pivotally connected at 77. Link 71 is secured to plate 118. By suitable stops or friction engaging devices the desired position of the platter 38 may be fixed. The slide is preferably mounted on a track to permit inward and outward movement of the arm 68 to locate the platform in the desired position to clear the edges of the workplace tabletop.

In FIG. 5 the platter 38 is shown in section with the mouse wire guide 90 in position. The slide arm 68 has a plate 118 which carries screw heads 120 for securing the platter 38 to the plate 113. At the front edge 40 of the platter 38 the channel 106 is shown with the clip 74 in section and projection 116 snapped fitted into channel 106 to secure the keyboard palm pad 70 to the platter. The keyboard palm pad comprises a shaped block 122 of resilient material such as a gel or foam. The block 122 has a plate 124 provided therein to receive the staple 126 to complete securement of the clip 74 to the keyboard palm pad 70.

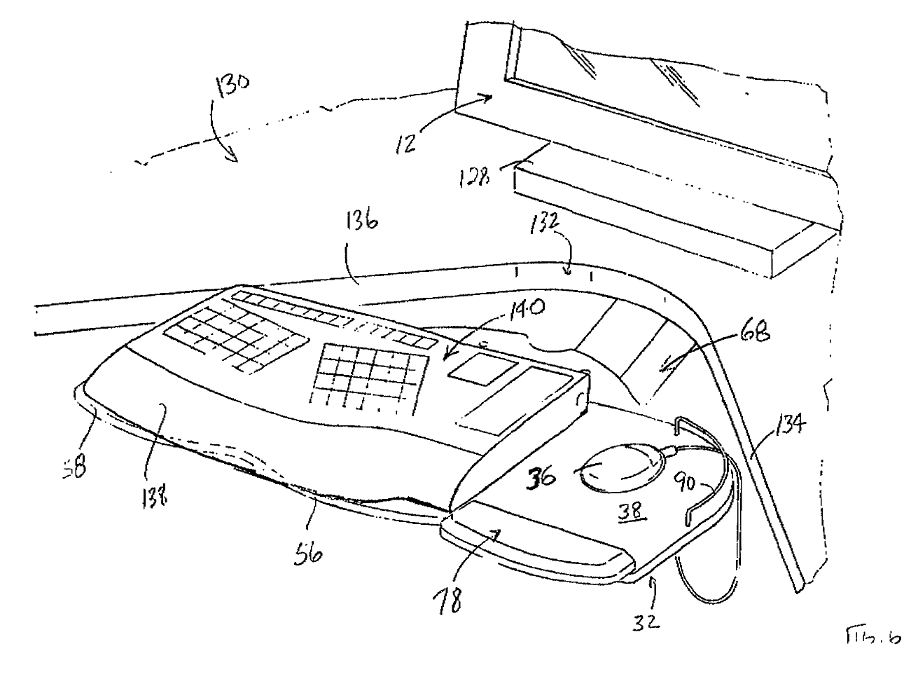

With reference to FIG. 6, the workstation includes the monitor 12 on a platform 128. The platform 128 rest on the workstation table top 130 which has a short radius of curvature of about 12 inches as indicted by the curve 132. The arm 68 positions the platform assembly 32 sufficiently away from the curve radius 132 having the side edges 134 and 136 to allow the platform platter 38 to move up and down as desired by the operator. The system shown in FIG. 6 includes the platter 38 without the keyboard palm rest because the V-shaped keyboard has its own palm rest 138 which is somewhat aligned with the two lobes 56 and 58. Correspondingly the remaining lobe 54 is covered with the mouse palm rest 78. This arrangement for the platform assembly allows the location of the V-shaped style of keyboard 140 on the platform and still accommodates a position for the mouse 36 on the platter 38 depending upon the operator's desire for right hand or left hand set up. The mouse wire guide 90 can be moved to the left hand side with the mouse palm rest 78 and the keyboard moved to the right where the curve rest 138 aligns itself at the curvature of lobes 54 and 56.

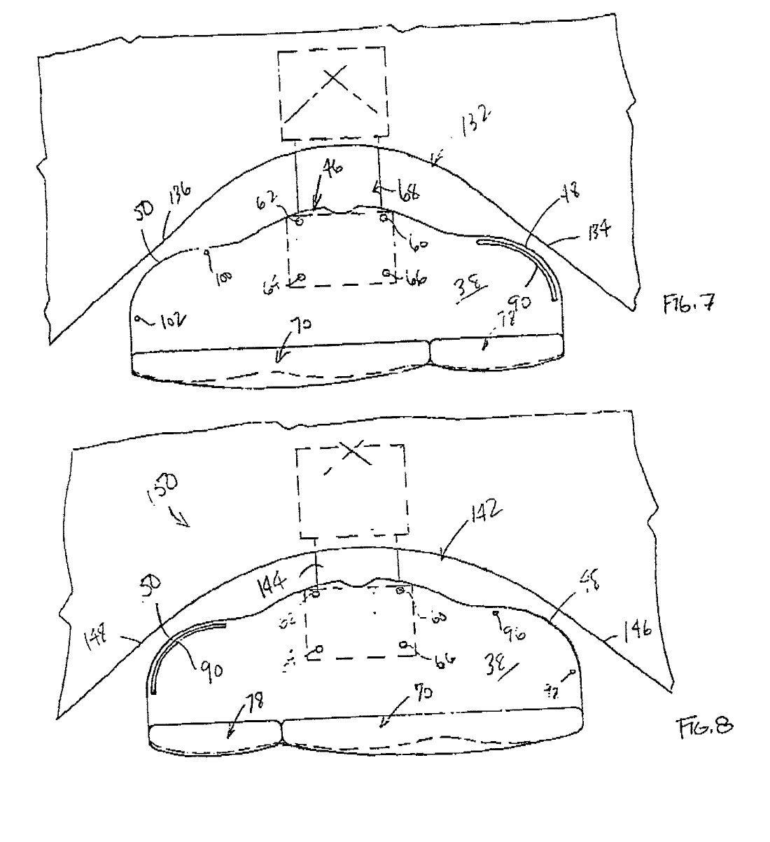

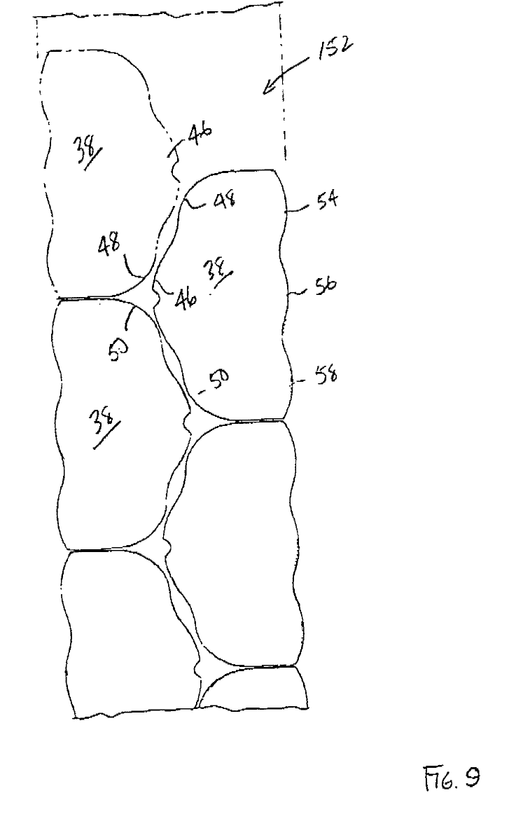

FIGS. 7 and 8 shows the relationship of the platform assembly relative to a twelve inch radius of curvature 132 as shown in FIG. 7 and an eighteen inch radius of curvature 140 two as shown in FIG. 8. The platter 38 is mounted to arm 68 by way of securements at 60, 62, 64 and 66. Securements 60 and 62 are provided in the rearwardly projected tongue 46 so as to position the radiused portions 48 and 50 rearwardly and clear of the side edges 134 and 136 of the workdesk 130. To provide for this clearance, an extended arm 68 is provided which is slightly longer and the shorter arm 140, 144 of FIG. 8. The securement is the same at 60, 62, 64 and 66. Arm 144 maybe somewhat shorter than arm 68 of FIG. 7. The radiused portions 48 and 50 readily clear the side edges 146 and 148 of the desk worksurface 150. In addition, the top views of FIGS. 7 and 8 shows the alternative of the keyboard palm rest 70 being on the left versus the keyboard palm rest 70 being on the right of FIG. 8.

The design for the platform platter 38 also lends itself to material economy as shown in FIG. 9. A sheet of stock 152 from which the platters are to be cut, can be laid out with the rear tongue portion 46 offset from the adjacent rear tongue portion 46 of the next platter so that the tongue portion 46 projects into the recess space defined by radius portions 48 of one platter and the adjacent radius portion 50 of the next adjacent planer. Depending upon the dimensions of the stock, for example, a typical 48 inch width for the stock, three rows of platters can be cut out from the stock with minimum material waste.

Accordingly, this invention provides a platform assembly which is universal for use with straight, radius or diagonal workstations, different types of keyboards and right and left hand mousing all on one platter surface. At the same time the shape of the board provides for significant savings in term of waste stock during cut out from the stock.

Although preferred embodiments of the invention have been described herein in detail, it will be understood by those skilled in the art that variations may be made thereto without departing from the spirit of the invention or the scope of the appended claims.

1) An integral keyboard and mouse platform assembly for mounting on a work desk, said platform being adapted for use on straight, curved or diagonal worksurfaces,
said platform comprising:
i) a platter having a front edge, opposing side edges and a rear edge, said rear edge being defined by a radiused transition from each side edge into a rearwardly projecting tongue, said front edge having a scalloped face with three symetrical forwardly projecting lobes;
ii) said rearwardly projecting tongue having securements on its underside for securement to a suitable mount;
iii) said side edges being space apart sufficiently to provide a keyboard support and a mouse support all on one level of an upper surface of said platter; and
iv) a keyboard palm rest for attachment to said front edge and extending across two of said forwardly projecting lobes and a mouse palm rest for attachment to said front edge and extending across one of said lobes to provide right or left hand mousing areas on said platter

2) An integral platform assembly of claim 1, wherein two of said lobes which are adjacent align with a v-shaped keyboard having integral palm rests with said keyboard palm rest removed.

3) An integral platform assembly of claim 1, wherein each of said keyboard and mouse palm rests have clips for releasably attaching the respective palm rest to a selected right or left hand application of platter.

4) An integral platform assembly of claim 3, wherein said platter has along its underside proximate said front edge, a detent for said clips for said keyboard and mouse palm rests.

5) An integral platform assembly of claim 1, wherein said platter has at each of said radiused transitions, a removable guide for a mouse wire and for retaining a mouse on said platter.

6) An integral platform assembly of claim 1, wherein each of said keyboard and mouse palm rests have an outwardly curved front edge and a straight rear edge, said palm rests having padded areas above said platter.

7) An integral platform assembly of claim 1, wherein said platter has a shape which reduces material waste when cut from a sheet of stock by staggering cut outs for said platter with said rear tongues offset from one another.

8) An integral platform assembly of claim 1, wherein a multiple of said securements for a mount are provided in said tongue.

9) An integral platform assembly of claim 1, in combination with a short slide for 18 inch radiused curved worksurfaces.

10) An integral platform assembly of claim 1, in combination with a long slide for 12 inch radiused curved worksurfaces.
